(19) United States
(12) Patent Application Publication
(10) Pub. No.: US 2018/0107654 A1
(43) Pub. Date: Apr. 19, 2018

(54) METHOD AND APPARATUS FOR MANAGING SYNONYMOUS ITEMS BASED ON SIMILARITY ANALYSIS

(71) Applicant: SAMSUNG SDS CO., LTD., Seoul (KR)

(72) Inventor: Dong Hoon JUNG, Seoul (KR)

(73) Assignee: SAMSUNG SDS CO., LTD., Seoul (KR)

(21) Appl. No.: 15/787,168

(22) Filed: Oct. 18, 2017

(30) Foreign Application Priority Data
Oct. 18, 2016 (KR) 10-2016-0135209

(51) Int. Cl. G06F 17/27

(52) U.S. Cl. CPC G06F 17/2795; G06F 17/278; G06F 17/277; G06F 17/2755

(57) ABSTRACT

A method for managing synonymous items based on similarity analysis is provided. The method comprises extracting (1-1)-th through (1-m)-th items, which are sub-items of a first item, from the first item, extracting (2-1)-th through (2-n)-th items, which are sub-items of a second item, from the second item, calculating a source-target (S-T) similarity by using similarities of the (1-1)-th through (1-m)-th items to the sub-items of the second item, calculating a target-source (T-S) similarity by using similarities of the (2-1)-th through (2-n)-th items to the sub-items of the first item, calculating the similarity between the first item and the second item by using the S-T similarity and the T-S similarity.

This application claims the benefit of Korean Patent Application No. 10-2016-0135209, filed on Oct. 18, 2016, in the Korean Intellectual Property Office, the disclosure of which is incorporated herein by reference in its entirety.

### BACKGROUND

### 1. Field

The present inventive concept relates to a method and apparatus for managing synonymous items based on similarity analysis, and more particularly, to a method of dividing a source item into words which are minimum units of meaning and calculating the similarity between the source item and a target item based on similarities of divided words, and an apparatus for performing the method.

### 2. Description of the Related Art

There are cases where various items need to be managed.

For example, a goal management system for assessing the degree to which an organization achieves its goals manages key performance indicators. The system should manage items indicating key performance indicators, such as a “10% increase in sales target” registered by organization A and a “50% increase in the number of registered members” registered by organization B.

In another example, instruction messages created to cope with various error situations are managed while services are provided to general users. Items indicating instruction messages such as “An ID must be entered.” and “The e-mail address you entered is invalid.” should be managed.

In another example, most systems that provide services to general users manage frequently asked questions (FAQs) to enhance user convenience. Therefore, it is required to manage items such as “Change your password and then ask an investigation agency for help” provided as an answer to a question “Someone tried access with my ID. Is it a hack?”

In another example, to construct a system, the logical structure of a database is modeled by analyzing real-world entities. That is, items indicating the name of a table representing an entity and the name of a column representing an attribute of an entity should be managed. A large system can have tens of thousands of tables.

To manage items (terminology) indicating specific information, a synonymous/similar word dictionary is used. That is, a person registers information indicating that a first item and a second item are the same item (A=B) in the dictionary in advance, and a synonym is searched for using this information.

In this method, however, there is a limitation in selecting a synonym from new words that are continuously being created. In addition, as the size and complexity of the system increases, the number of items to be managed increases exponentially. In such a situation, it is almost impossible for a person to artificially intervene and manage synonymous items whenever a new item is created.

Therefore, there is a need for a method of automatically selecting a synonym for an item created as a newly coined word without human intervention even when there are numerous items to be managed.

### SUMMARY

Aspects of the inventive concept provide a method of automatically calculating the similarity between terms created by combining words which are minimum units of meaning, the similarity between sentences, and the similarity between documents based on a synonymous/similar word dictionary, and an apparatus for performing the method.

Aspects of the inventive concept also provide a method of calculating the similarity between terms, between sentences and between documents and recommending another term, another sentence and another document to a user, and an apparatus for performing the method.

However, aspects of the inventive concept are not restricted to the one set forth herein. The above and other aspects of the inventive concept will become more apparent to one of ordinary skill in the art to which the inventive concept pertains by referencing the detailed description of the inventive concept given below.

In some embodiments, a method for managing synonymous items based on similarity analysis, comprising; extracting (1-1)-th through (1-m)-th items, which are sub-items of a first item, from the first item; extracting (2-1)-th through (2-n)-th items, which are sub-items of a second item, from the second item; calculating a source-target (S-T) similarity by using similarities of the (1-1)-th through (1-m)-th items to the sub-items of the second item; calculating a target-source (T-S) similarity by using similarities of the (2-1)-th through (2-n)-th items to the sub-items of the first item; and calculating the similarity between the first item and the second item by using the S-T similarity and the T-S similarity, wherein the S-T similarity is calculated based on how many sub-items constituting a source item are included in a target item, and the T-S similarity is calculated based on how many sub-items constituting the target item are included in the source item.

### BRIEF DESCRIPTION OF THE DRAWINGS

These and/or other aspects will become apparent and more readily appreciated from the following description of the embodiments, taken in conjunction with the accompanying drawings in which:

FIGS. 1A and 1B are diagrams for comparing a conventional item management method and an item management method according to an embodiment;

FIG. 2 is a diagram for defining a system of items used in embodiments;

FIGS. 3A and 3B are diagrams for defining similarity used in embodiments;

FIGS. 4A and 4B are diagrams for explaining rules on which a method of managing synonymous items based on similarity analysis according to an embodiment is based;

FIGS. 5A through 5C are diagrams for explaining equations used in a method of managing synonymous items based on similarity analysis according to an embodiment;

FIGS. 6 and 7 are diagrams for explaining a method of managing synonymous items based on similarity analysis according to an embodiment;

FIG. 8 is a diagram for explaining the expansion of a synonymous/similar dictionary according to an embodiment;

FIG. 9 is a flowchart illustrating a method of managing synonymous items based on similarity analysis according to an embodiment;

FIG. 10 illustrates the configuration of an apparatus for managing synonymous items based on similarity analysis according to an embodiment;

FIG. 11 is a diagram for explaining a method of managing synonymous items based on similarity analysis according to an embodiment;

FIGS. 12A and 12B illustrate a process of using the similarity between low-level items to calculate the similarity between high-level items according to an embodiment;

FIG. 13 illustrates a preprocessing process according to an embodiment;

FIGS. 14A through 17B illustrate specific examples for explaining an item management method according to an embodiment; and

FIG. 18 illustrates the hardware configuration of an apparatus for managing synonymous items based on similarity analysis according to an embodiment.

### DETAILED DESCRIPTION

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims Like reference numerals refer to like elements throughout the specification.

The terminology used herein is for the purpose of describing particular embodiments only and is not intended to be limiting of the invention. As used herein, the singular forms “a”, “an” and “the” are intended to include the plural forms as well, unless the context clearly indicates otherwise.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, the inventive concept will be described in more detail with reference to the accompanying drawings.

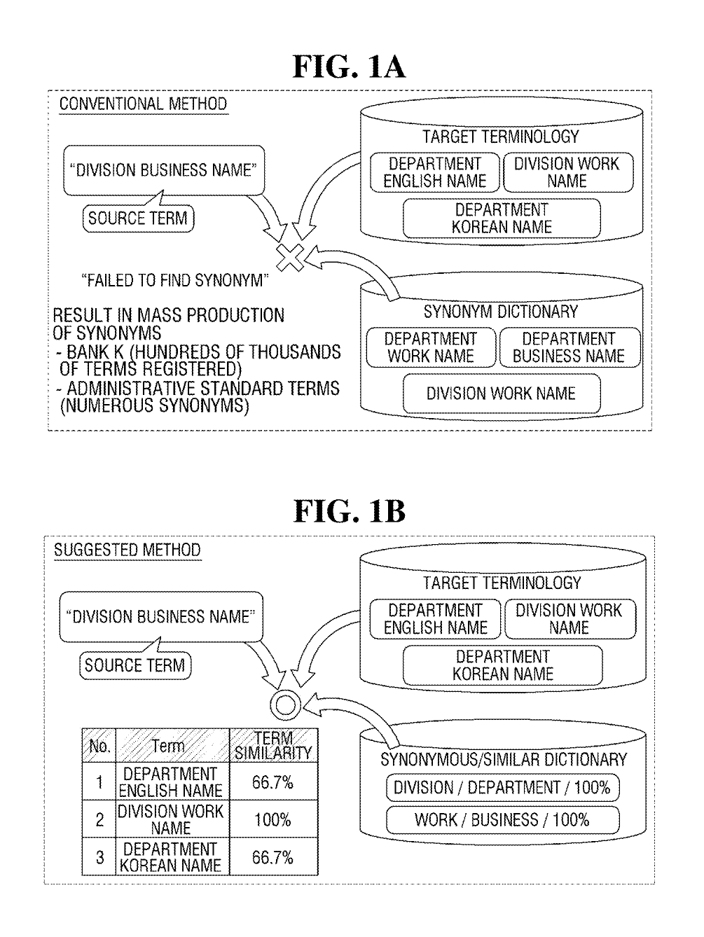

FIGS. 1A and 1B are diagrams for comparing a conventional item management method and an item management method according to an embodiment.

In FIG. 1A, the conventional item management method is illustrated. A target term can be thought of as a previously registered item. For example, the target term may be a previously created table name or a previously registered instruction message. A synonym dictionary is a list of synonyms that have been registered by people. Referring to FIG. 1A, the items [department work name], [department business name], and [division work name] are registered in the dictionary as having the same meaning. Hereinafter, [] will be used as a symbol representing an it

In the above situation, if a user creates a new item called [division name], it is necessary to verify whether the new item can be registered. That is, it is necessary to check whether the item [division business name] can be added as a new source term or whether a previously registered target term should be used instead. Here, a source term can be thought of a new item to be registered.

In the conventional item management method, a user decides whether to register a new term as an item by checking items one by one. In the example of FIG. 1A, [division business name] is an item consisting of a Korean word and loanwords from English and can be changed to [department work name] in Korean. Here, [department work name] is not yet registered as a target term. That is, since the [department work name] has not yet been created, the user may create the item [department work name] instead of creating the item [division business name].

In this process, however, the user intending to create a new item should also check the synonym dictionary. In the synonym dictionary, the items [department business name] and [division work name] are registered as synonyms for [department work name]. Here, since [division work name] is already registered as a target term, the user may finally decide to use [division work name] instead of the item [division business name].

In this way, when the user manages various items manually, an artificial process for changing [division business name] to [department work name] is required. In addition, a process of checking the synonym dictionary to change [department work name] to [division work name] is required.

However, since the user originally intended to register [division business name], it would be difficult for the user to change [division business name] to [division work name]. In addition, if there are numerous items registered in the synonym dictionary, unlike in the example of FIG. 1A, it is not easy for the user to check the items one by one.

That is, when a user manages items, there may be a situation where an item having the same or similar meaning as an item already registered as a target term is registered again. This occurs when the user fails to find the item [division work name] which is a synonym for the item [division business name] that the user tries to register.

In addition to the manual item management method performed by a user, an automatic item management method performed by a system using a synonymous/similar word dictionary is utilized. However, even when a system automatically manages items, it may conclude that it cannot find a synonym for [division business name] because the item [division business name:] that a user tries to register is not registered in the synonym dictionary. Therefore, even though there is an item called [division work name], the item [division business name] may be created.

As described above, in the conventional item management method, that is, either when a person manages items or when a system manages items using a synonym dictionary, a new item is often created by failing to find a registered item which is a synonym for the new item.

In the case of bank K, hundreds of thousands of terms are registered in a system. For example, there are various items such as an item to be input from a general user in order to open an account, an item to be input from a general user in order to set up automatic withdrawal, and an item to be input from a general user in order to receive a deposit when the deposit expires. Of these items, some items have the same content but different names, thus confusing users.

Also, a large number of synonyms are registered in an administrative system of the government. For example, an A document used by the government may use [dwelling], another B document may use [residence], and another C document may use [address]. Let's assume that demographic statistics by province are compiled based on these documents.

In this case, it can be confusing whether to use [dwelling] of the A document, [residence] of the B document, or [address] of the C document. When a data, warehouse system is constructed or when statistical information is generated, a considerable amount of money and time may be required for a process of identifying what each item of a document used by the government means, that is, a process of generating metadata.

When there are numerous items that need to be managed, a method of suggesting an existing item (=target term) synonymous with a new item (=source term) to be reused if possible instead of adding the new item (=source term) is required. To this end, problems of the above conventional methods will now be analyzed.

First, the manual item management method performed by a person, which is a first method among the conventional methods, may be efficient when the number of items is small. However, if the number of items increases exponentially, the efficiency of management decreases in inverse proportion to the increase. Therefore, this method has no room for improvement.

Next, in the case of the automatic item management method performed by a system which is a second method among the conventional methods, since the system manages items automatically, it can deal with the items even if the number of items increases exponentially.

However, the number of items is increased mostly by adding a term type item into which words are combined rather than by adding an item consisting of only one word. That is, whenever a newly coined term is created, a synonymous/similar word dictionary should be updated accordingly. Otherwise, a synonym for the newly coined term cannot be found among previously registered target terms even in the system-based automated method.

However, the work of finding a synonym for a newly coined term and registering the found synonym in the synonymous/similar word dictionary is performed by a user. Therefore, there is a limitation in the management method using the synonymous/similar word dictionary. For example, the number of new terms that can be created by selecting 2 out of 10 words is about 90. Thus, it is almost impossible for the user to register the new terms one by one.

In this regard, a method suggested herein should be a method of finding synonym even for a new term created by combining words. If a synonym for a newly coined term created by combining words can be found with this method, the method can be expanded to calculate the similarity of not only a term created by combining words to another term, but also the similarity of a sentence created by combining a term and a word to another sentence and, by extension, the similarity of a document created by combining sentences to another document.

For example, to provide various news to users by forming a cluster of news articles and excluding duplicate news articles, clustering is performed by calculating the similarity between news articles based on keywords alone in the conventional art. In this case, however, if keywords extracted from similar documents by applying an algorithm such as Term Frequency-Inverse Document Frequency (TF-IDF) are different from each other, the similarity between the similar documents is calculated to be low. Thus, clustering cannot be properly performed.

Among patent applications of Naver Corporation, Patent Publication No. 10-2011-0117440 A discloses a method in which keywords are extracted to calculate the similarity between two papers. In this method, however, since the similarity is calculated based on keywords alone, the similarity calculation may be insufficient.

Hence, the above application of Naver Corporation addresses this problem by additionally extracting keywords from a paper that a specific paper refers to or from a paper that refers to the specific paper and selecting various keywords. However, compared with this conventional art, the method suggested herein is a method that is applicable even if there is no reference relationship between documents. Specifically, it is a method of calculating the similarity between documents based on a synonymous/similar word for a word.

A specific similarity calculation method included in a method of managing synonymous items according to an embodiment will be described in detail later. For now, the effects of the method of managing synonymous items according to the embodiment will first be described. The method of managing synonymous items according to the embodiment can bring about effects as illustrated in FIG. 1B.

That is, when a user tries to register a source term [division business name] as a new item as in the example of FIG. 1A, even if the source term [division business name] is not registered in a synonymous/similar dictionary, the similarity between the source term and a target term which is a registered item can be calculated and provided to the user.

In the example of FIG. 1B, the item [division business name] has a similarity of 66.7% to the item [department English name], has a similarity of 100% to the item [division work name], and has a similarity of 66.7% to the item [department Korean name]. Therefore, the user can use the item [division work name] ininstead of adding the item [division business name].

Although the source term [division business name] is not registered in the synonymous/similar dictionary of the inventive concept, the item [division] and the item [business], which are words constituting the source term [division business name], are registered in the synonymous/similar dictionary in the form of (division, department, 100%) and (work, business, 100%). Therefore, it is possible to calculate the similarity of a new term created by combining these words to another term.

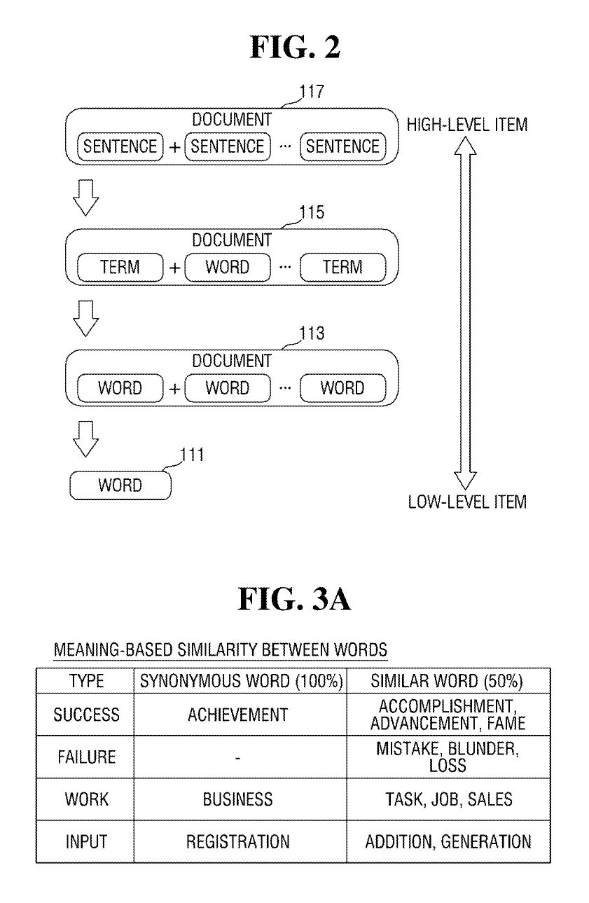

FIG. 2 is a diagram for defining a system of items used in embodiments.

Items used herein are data to be managed by a system. As described above, the items may be key performance indicators or instruction messages or frequently asked questions (FAQs) for users. Alternatively, the items may be the names of tables and columns constituting a database. Alternatively, the items may be documents such as papers, news articles and web pages or may be patent documents such as patent laid-open publications and patent publications.

These items are defined herein as having a certain system. A smallest unit of item is a word 111. The word 11l is a minimum unit having a meaning. If the word 111 is further broken up, its meaning disappears. The word 111 can be thought of as a concept corresponding to an element in chemistry.

Words 111 are combined into a term 113. That is, the term 113 consists of a combination of at least two words 111. The term 113 can be thought of as a concept corresponding to a molecule into which elements are combined in chemistry.

Terms 113 or words 111 are combined into a sentence 115. That is, the sentence 115 consists of a combination of at least two words 111 or terms 113. The sentence 115 can also be distinguished by a symbol called ‘period.’

Sentences 115 are combined into a document 117. That is, the document 117 consists of a combination of at least two sentences 115. A sentence or document can be thought of as a concept corresponding to a polymer compound in chemistry.

An item becomes higher in level and larger in size from the word 111 toward the term 113, the sentence 115 and the document 117. That is, the word 111 is a low-level item and a smallest unit, and the document 117 is a high-level item and a largest unit. An item is defined as a high-level item as it is closer to the document 117 and defined as a low-level item as it is closer to the word 111.

However, the system of items illustrated in FIG. 2 is merely an example used to facilitate the understanding of the inventive concept. For example, sentences 115 can be combined into a paragraph (not illustrated), and paragraphs (not illustrated) can be combined into a document 117.

Although the system of items illustrated in FIG. 2 is merely an example, the following description will be made based on this system of the word 111—the term 113—the sentence 115—the document 117.

The above-described example of items can be applied to the system of items of FIG. 2 as follows. Items such as the names of tables and columns in a database correspond to the words 111 and the terms 113. In addition, items such as key performance indicators correspond to the terms 113 and the sentence 115. Also, items such as instruction messages and FAQs correspond to the sentences 115 and the document 117. Lastly, items such as paper, news articles, web pages and patent documents correspond to the documents 117.

Items to be managed by a system include various items ranging from low-level items such as the words 111 to high-level items such as the documents 117. The process of calculating similarities of various data ranging from low-level items to high-level items will be described later with reference to the drawings.

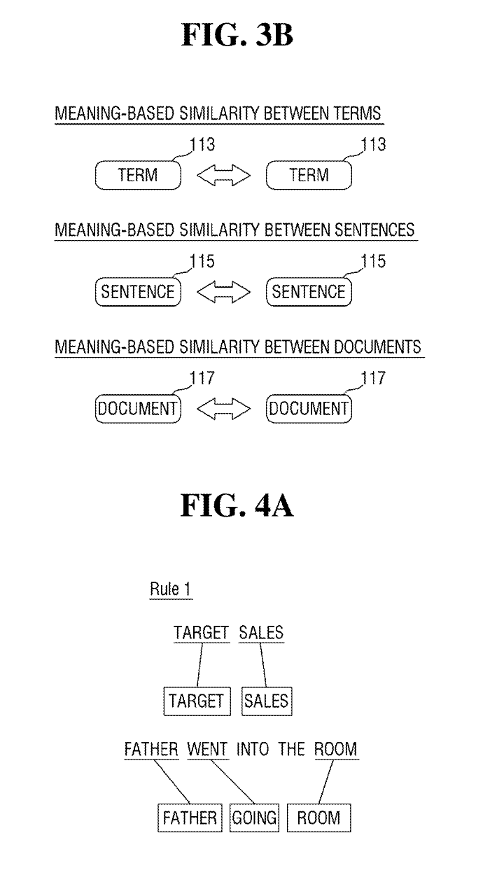

FIGS. 3A and 3B are diagrams for defining similarity used in embodiments.

FIG. 3A is a table for defining the similarity between words. In FIG. 3A, the meaning-based similarity between words is illustrated. For ease of understanding, similarity is defined for two types of words: a synonymous word that has the same meaning as a specific word and a similar word that does not have the same meaning as the specific word but has a similar meaning to the specific word.

Referring to the example of FIG. 3A, [success] and [achievement] have the same meaning. In the case of synonymous words, it is assumed that the similarity between two words 111 is 100%. In addition, [accomplishment], [advancement], and [fame] are similar words for [success]. In the case of similar words, it is assumed that the similarity between two words 111 is 50%. Althoug not shown in FIG. 3A, the similarity be assume to be 30% or 70%.

As for [failure], there is no synonymous word. However, [failure] has [mistake], [blunder], and [loss] as similar words. In addition, [work] has [business] as a synonymous word and [task], [job] and [sales] as similar words. Lastly, [input] has [registration] as a synonymous word and [addition] and [generation] as similar words.

It is assumed that a synonymous/similar dictionary for the words 111 has already been created as in the example of FIG. 3A. A word 111 is a minimum unit of meaning, and the similarity between words 111 is already stored in the dictionary according to whether the words 111 are synonymous words or similar words.

When the similarity between the words 111 is not stored in the dictionary, it may be automatically calculated and stored. This will be described in more detail later. However, for now, the description will be made based on the assumption that the similarity between words 111 is already stored in the dictionary according to whether the words 111 are synonymous words or similar words.

In FIG. 3B, terms 113, sentences 115 and documents 117 which are higher-level items than words 111 are illustrated. Based on meaning, the similarity between the terms 113 may be calculated to obtain the similarity between the terms 113, the similarity between the sentences 115 may be calculated to obtain the similarity between the sentences 115, and the similarity between the documents 117 may be calculated to obtain the similarity between the documents 117.

Here, since the similarity between the words 111 is stored in the dictionary as illustrated in FIG. 3A, it can be easily obtained. However, in many cases, the similarity between the terms 113 obtained by comparing the term 113, the similarity between the sentences 115 obtained by comparing the sentences 115, or the similarity between the documents 117 obtained by comparing the documents 117 are not stored in the dictionary.

For example, when a new term 113 is created by combining words 111, it may not exist in the synonymous/similar dictionary. Instead, only the words 111 that constitute the new term 113 may generally exist in the synonymous/similar dictionary.

Therefore, the method suggested herein is a method of calculating the similarity of the term 113 by using similarities of the words 111 that constitute the term 113. A number of assumptions are required to calculate the similarity of the term 113 by using the similarities of the words 111 that constitute the term 113.

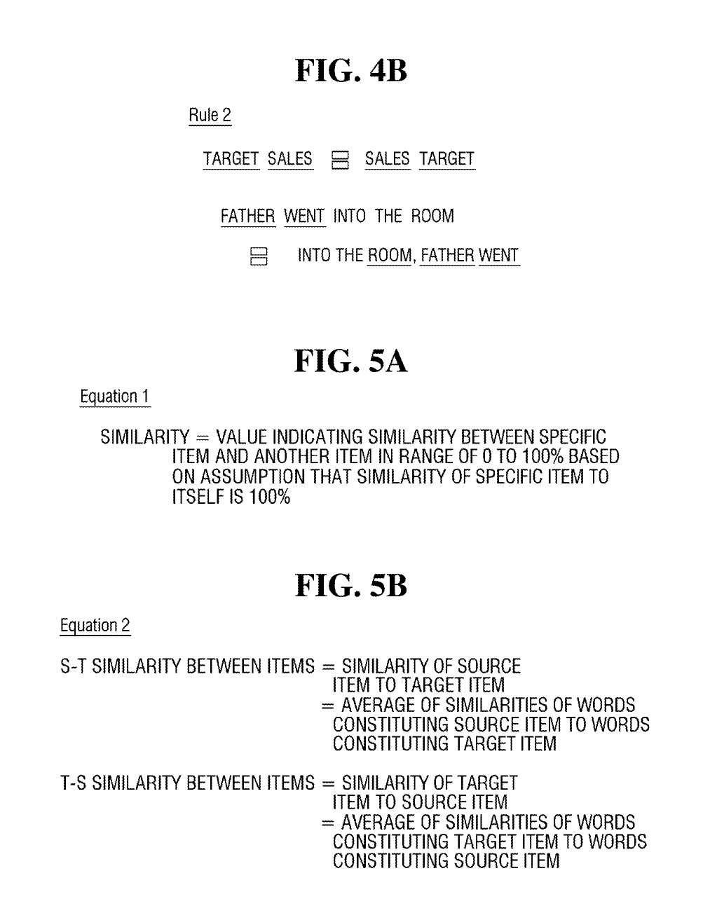

FIGS. 4A and 4B are diagrams for explaining rules on which a method of managing synonymous items based on similarity analysis according to an embodiment is based.

In FIG. 4A, rule 1 is illustrated. Rule 1 is an assumption that parts of speech such as nouns, adverbs, adjectives and verbs have meaning in terms, sentences and documents and that postpositions and endings do not affect meaning. Therefore, postpositions and endings may be removed when the similarity between terms, between sentences, and between documents is calculated.

In addition, in principle, a verb should be changed to a noun form for ease of comparison. However, even if the verb is not in the noun form, it is also possible to extract the verb in a root form by excluding an ending and compare the extracted word with other words. That is, to compare [went] in the example of FIG. 4A with other words, [went] may be changed to the noun form such as [going] or the root form such as [go].

Referring to FIG. 4A, in order to calculate the similarity of the term [target sales], the term is broken up into the words [target] and [sales]. In addition, in order to calculate the similarity of the sentence [Father went into the room.], the sentence is broken up into [father], [room], and [going].

High-level items such as terms, sentences and documents need to be broken up into low-level items in order to calculate similarities of the high-level items to other terms. Here, a preprocessing process for removing postpositions and endings and a preprocessing process for converting a verb into the noun form or the root form are performed.

In FIG. 4B, rule 2 is illustrated. Rule 2 is an assumption that order does not affect meaning. Referring to the example of FIG. 4B, the term [target sales] and the term [sales target] have the same meaning. In addition,the sentence [Father went into the room.] and the sentence [into the room, father went.] have the same meaning.

Nuance can vary slightly depending on order. However, in most cases, there is no significant difference in meaning. Since meaning is mostly the same even if order is changed, the order of words, the order of terms, and the order of sentences are not taken into consideration in similarity calculation.

The gain of accurate similarity calculation that can be obtained by calculating similarity by reflecting order is not greater than the loss of algorithm complexity that is added by calculating similarity by reflecting order. Therefore, order may be ignored in similarity calculation, thus making faster calculation possible.

In similarity calculation according to the inventive concept, the word [father] in a first sentence of FIG. 4B is compared with the words [room], [father], and [going] in a second sentence. Then, a word having a highest degree of similarity to he word [father] among the above, words is used as the similarity of the word [father]. Therefore, order of words is changed, the word having the highest degree of similarity is unaffected by the order, unless the order is reflected in similarity. Therefore, the order of items will be ignored herein.

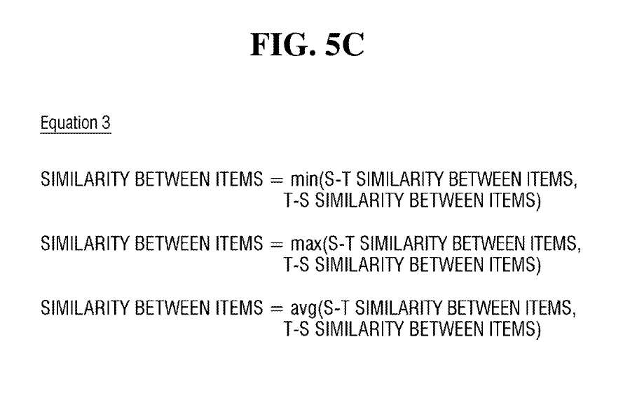

Based on the two assumptions described above with reference to FIGS. 4A and 413, specific equations used to calculate the similarity between specific items will be described with reference to FIGS. 5A through 5C.

FIGS. 5A through 5C are diagrams for explaining equations used in a method of managing synonymous items based on similarity analysis according to an embodiment.

In FIG. 5A, Equation 1 is illustrated. Equation 1 defines that “similarity is a value indicating the similarity between a specific item and another item to be compared in the range of 0 to 100% based on the assumption that the similarity of the specific items is 100%.” That is, if two items be compared are the same, the similarity between them is 100%. This is a natural result.

If the two items to be compared are different, the similarity between them may be calculated and expressed as a value in the range of 0 to 100%. As in the example of synonymous words and similar words described above with reference to FIG. 3A, when two words are different, the similarity between them may be considered as 100% if the two words are synonymous words and may be considered as 50% if the two words are similar words.

Even between similar words, there may be a difference in the degree of similarity in meaning. Therefore, the similarity between similar words may actually have a value other than 50%. This will be described in more detail later. For now, it is assumed for ease of understanding that synonymous words have a similarity of 100% and similar words have a similarity of 50%.

If a source item is A and a target item to be compared is A, the similarity between them is 100% according to Equation 1. However, if the source item is A and the target item to be compared is B, the similarity between the items A and B should be calculated. Here, Equation 2 and Equation 3 can be used.

Referring to FIG. 5B, Equation 2 provides two criteria for calculating the similarity between the items A and B.

One is a source-target (S-T) similarity defined as a result of comparing the item A, which is the source item, with the item B which is the target item. The S-T similarity is calculated based on how many words constituting the source item A are included in the target item B.

The other is a target-source (T-S) similarity defined as a result of comparing the item B, which is the target item, with the item A which is the source item. The T-S similarity is calculated based on how many words constituting the target item B are included in the source item A.

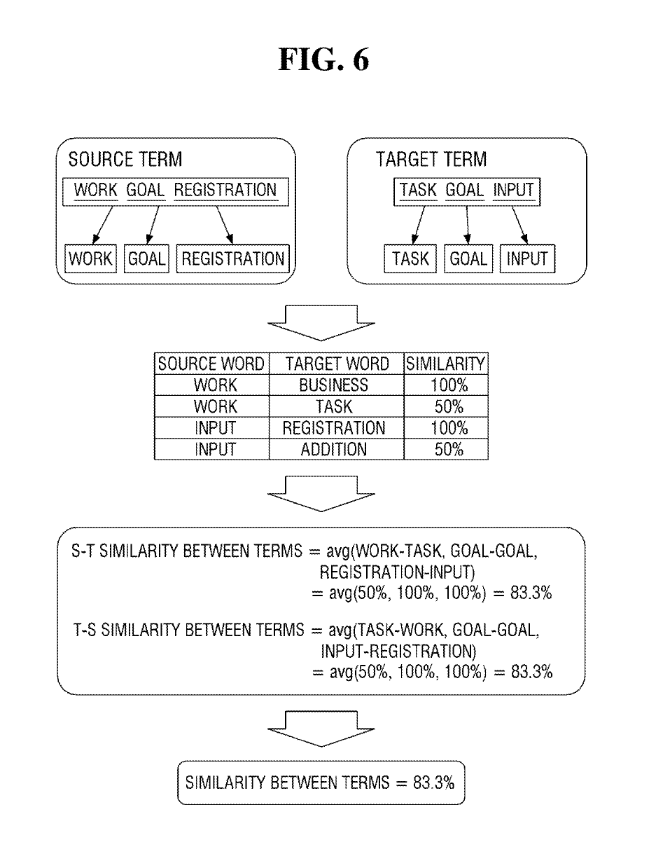

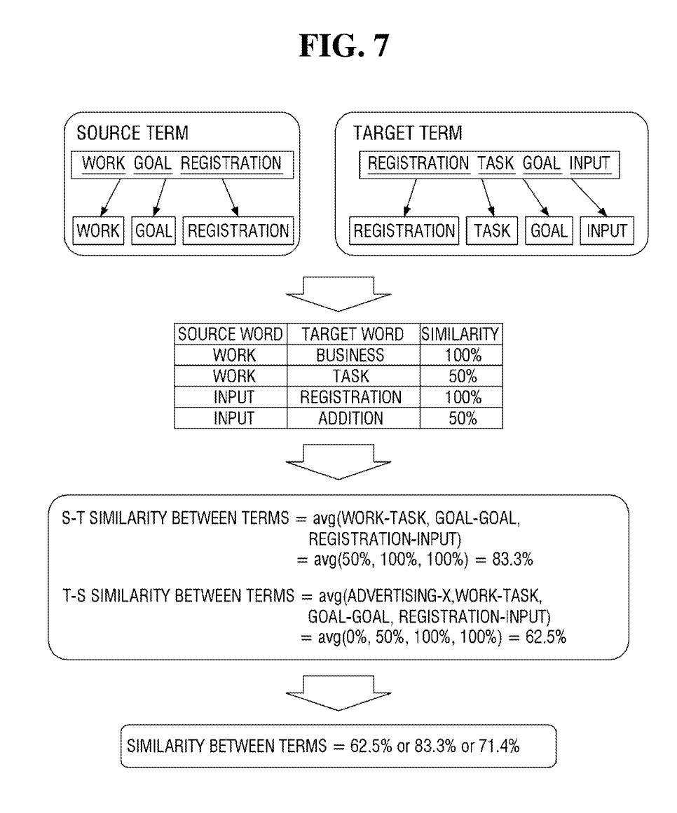

A method of calculating the S-T similarity and the T-S similarity will be described later with reference to FIGS. 6 and 7 by using specific examples. After the S-T similarity and the T-S similarity are calculated using the source item A and the target item B, the similarity between the items A and B can be calculated using the two similarities.

In FIG. 5C, Equation 3 for calculating the similarity between A and B using the S-T similarity and the T-S similarity is illustrated. Referring to Equation 3 of FIG. 5C, the similarity between the items A and B may be calculated as a minimum value or a maximum value among the S-T similarity and the T-S similarity, or an average value of the S-T similarity and the T-S similarity.

However, Equation 3 of FIG. 5C is merely an example, and the inventive concept is not limited to this example. Any method that calculates two values to produce one value can be included in Equation 3. Simple examples may include multiplication and addition.

After the S-T similarity and the T-S similarity are calculated using Equation 2, the similarity between a source item and a target item is calculated using Equation 3.

That is, if the similarity between the items A and B is not registered in the synonymous/similar dictionary, it can be calculated using similarities between words constituting the item A and words constituting the item B, as in Equations 2 and 3. In other words, the similarity between the terms 113 can be calculated using similarities between the words 111 which are the smallest units, and, by extension, the similarity between the sentences 115 and the similarity between the documents 117 can also be obtained in this way.

Therefore, even if a new term or a new sentence is created, it is possible to calculate the similarity of the new term or sentence to another term or sentence. However, the inventive concept requires the premise that the similarity between the words 111 has been registered. For now, it will be assumed that the similarity between the words 111 is already registered, and a method of automatically registering the similarity between the words 111 will be described in detail later.

FIGS. 6 and 7 are diagrams for explaining a method of managing synonymous items based on similarity analysis according to an embodiment.

Referring to FIG. 6, an item to be newly registered is [work goal registration], and an item already created is [task goal input]. That is, [work goal registration] on the left side is a source term, and [task goal input] on the right side is a target term.

In the middle of FIG. 6, a synonymous/similar dictionary is illustrated. However, [work goal registration] and [task goal input] do not exist in the dictionary. In this case, in the conventional item management method, it may be determined that the two terms are different from each other and that the term [work goal registration] can be registered. In the inventive concept, however, the similarity between the two terms can be calculated even if the item [work goal registration] does not exist in the synonymous/similar dictionary.

In order to calculate the similarity between the term [work goal registration] and the term [task goal input], each of the term [work goal registration] and the term [task goal input] is divided into words that are the smallest units of meaning. The source term [work goal registration] may be divided into three words [work], [goal], and [registration]. Likewise, the target term [task goal input] may be divided into three words [task], [goal], and [input].

Then, the S-T similarity is calculated. The word [work] in the source term is registered in the synonymous/similar dictionary as having a similarity of 50% to the word [task] in the target term. That is, since the similarity between [work] and [task] is 50%, the two words are similar words. In addition, the word [goal] in the source term is the same as the word [goal] in the target term. In this case, the similarity between the two words is 100% according to Equation 1. Lastly, the word [registration] in the source term is registered in the synonymous/similar dictionary as having a similarity of 100% to the word. [input] in the target term. That is, since the similarity between [registration] and [input] is 100%, the two words are synonymous words.

The S-T similarity can be calculated by taking the average of similarities of words constituting a source term to words constituting a target term. Therefore, in the example of FIG. 6, the S-T similarity may be calculated to be 83.3% by avg(work-task, goal-goal, registration-input)=avg(50%, 100%, 100%)=83.3%.

Likewise, the T-S similarity may be calculated to be 83.3% by avg(task-work, goal-goal, input-registration)=avg(50%, 100%, 100%)=83.3%.

After the S-T similarity and the T-S similarity are calculated, the similarity between [work goal registration] and [task goal input] is calculated using the two values. As described above in Equation 3, the minimum value, the maximum value, and the average value can be utilized. In the case of FIG. 6, the S-T similarity is 83.3%, and the T-S similarity is 83.3%. Therefore, the minimum, maximum, and average values are all 83.3%.

As apparent from FIG. 6, even if the two items [work goal registration] and [task goal input] are not registered in the synonymous/similar dictionary, the similarity between the two terms can be calculated by dividing each of the two terms into words and using similarities between the words of the two terms. If the similarity between the two terms is greater than a preset value, a user may be suggested to use the existing item instead of adding a new item.

Calculating the similarity between two terms using the S-T similarity and the T-S similarity is intended to increase the accuracy of similarity. As can be seen in FIG. 6, the value of the S-T similarity and the value of the T-S similarity are the same in the case of low-level items such as terms. However, since a higher-level item includes a greater number of words or terms, the value of the S-T similarity and the value of the T-S similarity may often be different from each other in the case of high-level items. A case where the value of the S-T similarity and the value of the T-S similarity are different will now be described with reference to FIG. 7.

Referring to FIG. 7, an item to be newly registered is [work goal registration], and an item already created is [advertising task goal input]. That is, [work goal registration] on the left side is a source term, and [advertising task goal input] on the right side is a target term.

In the middle of FIG. 7, a synonymous/similar dictionary is illustrated. However, as in FIG. 6, [work goal registration] and [advertising task goal input] do not exist in the dictionary. In this case, in the conventional item management method, it may be determined that the two terms are different from each other and that the term [work goal registration] can be registered. In the inventive concept, however, the similarity between the two terms can be calculated even if the item [work goal registration] does not exist in the synonymous/similar dictionary.

In order to calculate the similarity between the term [work goal registration] and the term [advertising task goal input], each of the term [work goal registration] and the term [advertising task goal input] is divided into words that are the smallest units of meaning. The source term [work goal registration] may be divided into three words [work], [goal], and [registration]. Likewise, the target term [advertising task goal input] may be divided into four words [advertising], [task], [goal], and [input].

Then, the S-T similarity is calculated. The S-T similarity may be calculated to be 83.3% by avg(work-task, goal-goal, registration-input)=avg(50%, 100%, 100%)=83.3%, as in the example of FIG. 6.

However, the T-S similarity may be different from the example of FIG. 6 because a word corresponding to the word [advertising] in the target term does not exist in the source term. Therefore, the T-S similarity may be calculated to be 62.5% by avg(advertising-X, task-work, goal-goal, input-registration)=avg(0%, 50%, 100%, 100%)=62.5%.

In the example of FIG. 7, the S-T similarity and the T-S similarity have different values, unlike in the example of FIG. 6. Therefore, if the similarity between [work goal registration] and [advertising task goal input] is calculated using the two values, the minimum value is 62.5%, the maximum value is 83.3%, and the average value is 72.9%. Therefore, the similarity between [work goal registration] and [advertising task goal input] can be determined to be any one of 62.5%, 83.3%, and 72.9%?) as needed.

It is also possible to calculate a new similarity value by performing an arithmetic operation on the S-T similarity of 83.3% and the T-S similarity of 62.5% using various equations other than the minimum value, the maximum value and the average value. The similarity value calculated using the S-T similarity and the T-S similarity may be stored in the synonymous/similar dictionary.

The similarity between [work goal registration] and [task goal input] calculated in the example of FIG. 6 and the similarity between [work goal registration] and [advertising task goal input] calculated in the example of FIG. 7 can be used to calculate the similarity between higher-level items including the above terms, for example, to calculate the similarity between sentences or documents.

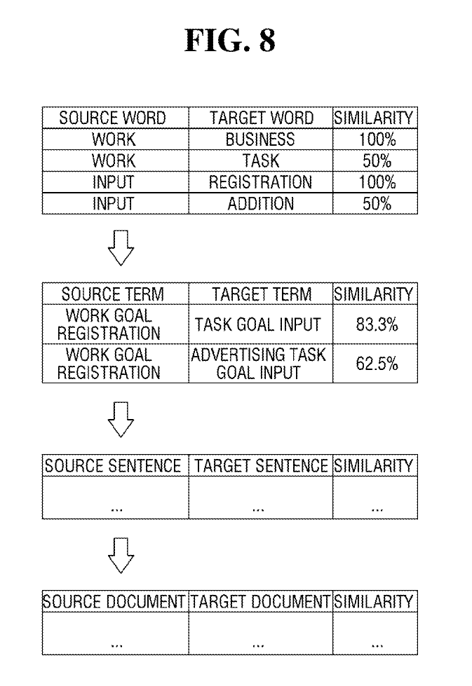

FIG. 8 is a diagram for explaining the expansion of a synonymous/similar dictionary according to an embodiment.

At the top of FIG. 8, a synonymous/similar word dictionary is illustrated. In FIGS. 6 and 7, the similarity between two terms is calculated using the synonymous/similar word dictionary. Then, the calculated similarity is stored in the synonymous/similar word dictionary. Referring to FIG. 8, a synonymous/similar term dictionary is illustrated below the synonymous/similar word dictionary.

Referring to the middle of FIG. 8, the similarity between the term [work goal registration] and the term [task goal input] is registered as 83.3% in the synonymous/similar term dictionary, and the similarity between the term [work goal registration ] and the term [advertising task goal input] is registered as 62.5%. The synonymous/similar word dictionary and the synonymous/similar term dictionary can be used to create a synonymous/similar sentence dictionary. Also, a synonymous/similar document dictionary can be created.

For example, in the case of patent document search, if invention A is a device for displaying an advertisement, a user searches for patent documents by using a search formula including “(information or image or video or advertisement or information or video or advertising).” Then, the user has to manually exclude noise and find a patent document similar to invention A by checking the found patent documents one by one.

On the other hand, according to the inventive concept, if the name of invention A or the specification of invention A is selected, it is possible to automatically find a patent document including a lot of synonymous or similar words for words included in the name of invention A or a patent document including a lot of synonymous or similar words for words included in the specification of invention A.

Even if a person does not write a search formula including synonymous or similar words for words indicating features of invention A, a patent document in a similar technical field can be easily found by using the synonymous/similar dictionary.

Likewise, if a specific paper is selected, a paper having similar content to the specific paper can be automatically found. Alternatively, if specific news is selected, news having similar content to the specific new can be automatically gathered to form a cluster. Compared with the conventional art that calculates the similarity between documents simply based on keywords, the inventive concept calculates the similarity between documents by further utilizing synonymous/similar words for keywords included in a dictionary. Therefore, a similar document can be found more accurately.

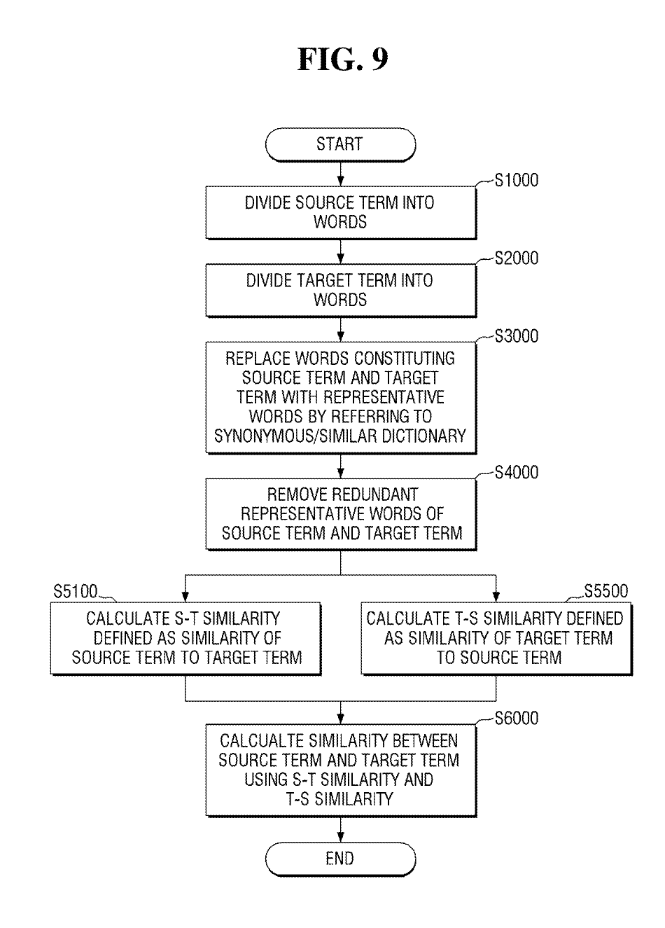

FIG. 9 is a flowchart illustrating a method of managing synonymous items based on similarity analysis according to an embodiment.

Referring to FIG. 9, a source item to be analyzed is divided into smaller items (operation S1000). Also, a target item is divided into smaller items (operation S2000). If the source item is a document, it is divided into sentences. If the source item is a sentence, it is divided into terms. In addition, if the source item is a term, it is divided into words.

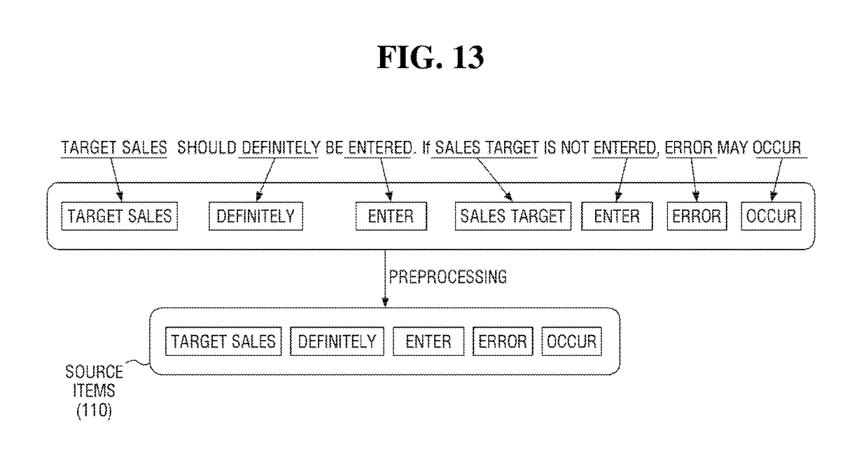

After each of the source item and the target item is divided into lower-level items, preprocessing processes are performed. As described above with reference to FIGS. 4A and 4B, the preprocessing process for removing postpositions and endings and the preprocessing process for converting verbs into a noun form or a root form are performed. In addition, the lower-level items may be replaced with representative items (operation S3000), and redundant representative words may be removed (operation S4000). The preprocessing process for replacing lower-level items with representative words and removing redundant representative words will be described in more detail later with reference to FIG. 13.

The preprocessing process for removing postpositions and endings, the preprocessing process for converting verbs, and the preprocessing process for removing redundant representative words (operations S3000 and S4000) are not essential processes but optional processes. However, the preprocessing process for removing postpositions and endings or the preprocessing process for converting verbs may be performed for the convenience of similarity calculation, and the preprocessing process for removing redundant representative words may be performed to improve the accuracy of similarity calculation.

After the completion of the preprocessing processes on the source item and the target item, two types of similarity are calculated for more accurate similarity calculation. That is, an S-T similarity is calculated (operation S5100), and a T-S similarity is calculated (operation S5500). Finally, the similarity between the source item and the target item is calculated using the S-T similarity and the T-S similarity (operation S6000). In the process of calculating the similarity between the source item and the target item, functions such as a. minimum value, a maximum value and an average value can be used.

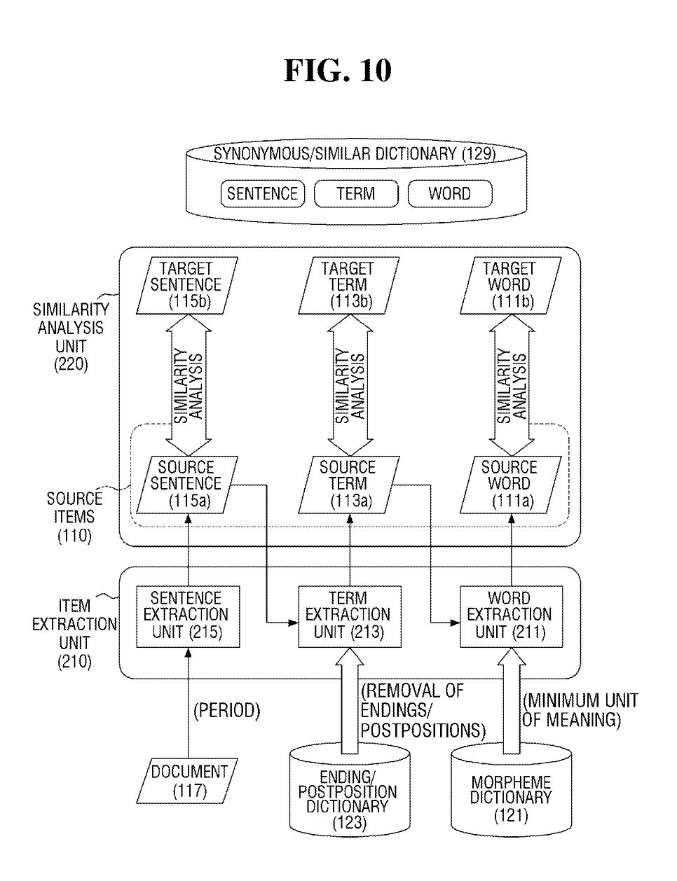

FIG. 10 illustrates the configuration of an apparatus for managing synonymous items based on similarity analysis according to an embodiment.

Referring to FIG. 10, a document 117, which is the largest unit as a source item, is illustrated at the bottom. To calculate the similarity of the document 117 to a target document by analyzing the document 117, a sentence extraction unit 215, a term extraction unit 213, and a word extraction unit 211 are required.

First, a sentence should be extracted from the document 117. The sentence extraction unit 215 extracts the sentence from the document 117 based on a period. The extracted sentence becomes a source sentence 115a and is compared with a target sentence 115b extracted from the target document. If the similarity between the source sentence 115a and the target sentence 115b is not registered in a synonymous/similar dictionary 129, each of the source sentence 115a and the target sentence 115b should be divided into smaller items.

The term extraction unit 213 extracts a term from the source sentence 115a. At this time, a preprocessing process may be performed using an ending/postposition dictionary 123. The term can also be extracted from the source sentence 115a using spacing. The term extracted from the source sentence 115a becomes a source term 113a and is compared with a target term 113b extracted from the target sentence 115b. If the similarity between the source term 113a and the target term 113b is not registered in the synonymous/similar dictionary 129, each of the source term. 113a and the target term 113b should also be divided into smaller items.

The word extraction unit 211 extracts a word from the source term 113a. At this time, a morpheme dictionary 121 can be used. The word extracted from the source term 113a becomes a source word 111a and is compared with a target word 111b extracted from the target term 113b.

Since it has been assumed that the similarity between words is registered in the synonymous/similar dictionary 129, even if the document 117 to be analyzed does not exist in the synonymous/similar dictionary 129 or even if the source sentence 115a does not exist in the synonymous/similar dictionary 129, the similarity can be calculated by dividing the document 117 or the source sentence 115a into smallest units of meaning.

Referring to FIG. 10, the source sentence 115a, the source term 113a, and the source word 111a correspond to source items 110. A similarity analysis unit 220 may compare the source sentence 115a, the source term 113a and the source word 111a with the target sentence 115b, the target term 113b and the target word 111b registered in the synonymous/similar dictionary 129 to calculate the similarity between the source sentence 115a and the target sentence 115b, the similarity between the source term 113a and the target term 113b, and the similarity between the source word 111a and the target word 111b.

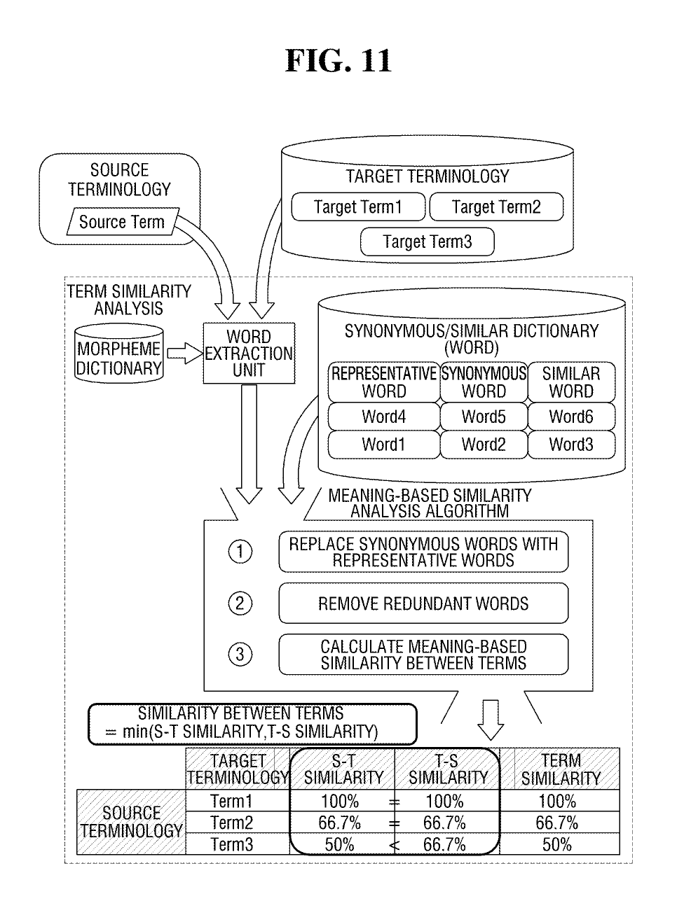

FIG. 11 is a diagram for explaining a method of managing synonymous items based on similarity analysis according to an embodiment.

Referring to FIG. 11, in order to calculate the similarity between a source term and a target term already registered in a system, it is checked whether the source term and the target term exist in a synonymous/similar dictionary. If the source term and the target term do not exist in the synonymous/similar dictionary, each of the source term and the target term is divided into words by using a word extraction unit that utilizes a morpheme dictionary.

Then, the S-T similarity and the T-S similarity between the source term and the target term are calculated based on similarities between source words and target words registered in the synonymous/similar dictionary. In this process, a preprocessing process for removing redundant representative words may be performed.

To remove redundant representative words, representative words registered in the synonymous/similar dictionary should be used. The reason why redundant representative words should be removed and the process of removing the redundant representative words will be described in more detail later with reference to FIG. 13. However, the process of removing redundant representative words is an optional process.

After the S-T similarity and the T-S similarity are calculated, the final similarity between the source term and the target term is calculated using the two similarities. The similarity can be calculated by using various functions. In the example of FIG. 11, a “min” function, which is the minimum value, is used. At the bottom of FIG. 11, a table showing the similarity between the source term and the target term is illustrated.

Referring to FIG. 11, the S-T similarity between the source term and a first target term is 100%, the T-S similarity is 100%, and, finally, the similarity between the two terms is 100%. Likewise, the S-T similarity between the source term and a second target term is 66.7%, the T-S similarity is 66.7%, and, finally, the similarity between the two terms is 66.7%. Likewise, the S-T similarity between the source term and a third target term is 50%, the T-S similarity is 66.7%, and, finally, the similarity between the two terms is 50%.

If the similarity is calculated as described above, the system may suggest using the previously registered first target term rather than registering the source term because the first target term having the same meaning as the source term is available. This can prevent multiple synonyms from being registered in the system.

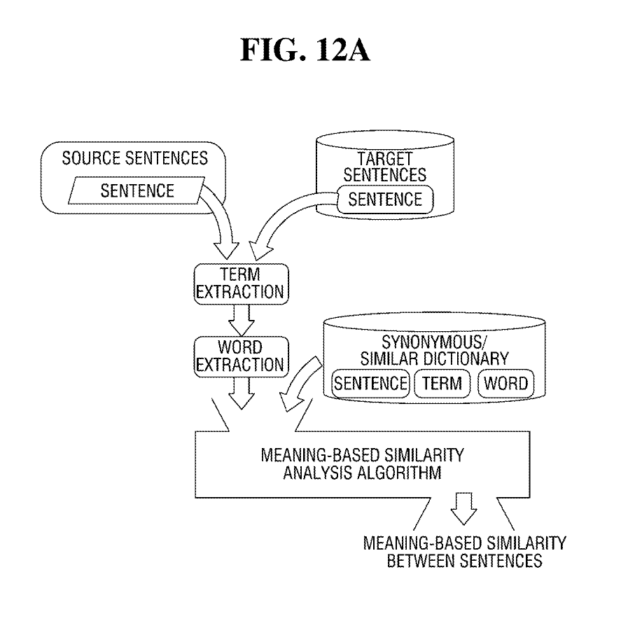

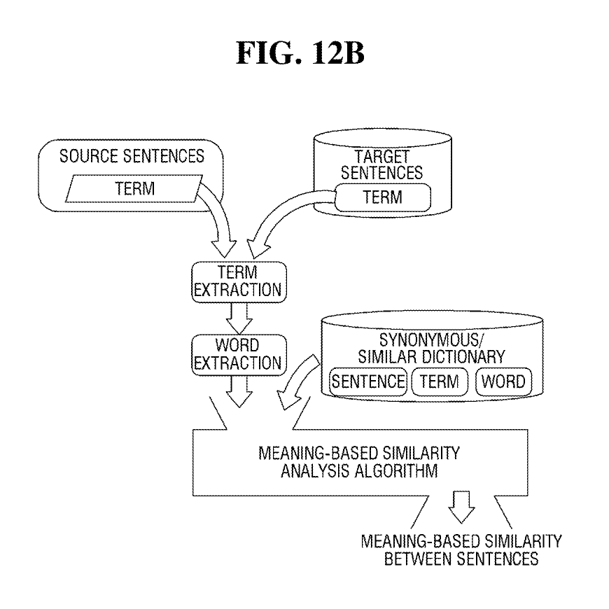

FIGS. 12A and 12B illustrate a process of using the similarity between low-level items to calculate the similarity between high-level items according to an embodiment.

FIG. 12A is a simple version of FIG. 11. In order to calculate the similarity between a source term and a target term, a synonymous/similar dictionary is referred to. If the source term and the target term are not registered in the dictionary, it is difficult to calculate the similarity between the source term and the target term as they are. Therefore, words constituting the source term and words constituting the target term are extracted using a word extraction unit.

Then, the S-T similarity defined as the similarity of the words constituting the source term to the words constituting the target term is calculated. Conversely, the T-S similarity defined as the similarity of the words constituting the target term to the words constituting the source term is calculated. Finally, the similarity between the source term and the target term is calculated using the two similarities.

FIG. 12A can be expanded to FIG. 12B in which a process of calculating the similarity between sentences is illustrated. When the similarity between sentences is calculated, the synonymous/similar dictionary is also referred to. If a source sentence and a target sentence are not registered in the synonymous/similar dictionary, it is difficult to calculate the similarity between the source sentence and the target sentence as they are. Therefore, terms constituting the source sentence and terms constituting the target sentence are extracted using a term extraction unit.

If the extracted source terms and target terms are not registered in the synonymous/similar dictionary, source words and target words, which are lower-level items, are extracted using the word extraction unit. Since words, which are the smallest units of meaning, are registered in the synonymous/similar dictionary, the similarity between the source sentence and the target sentence can be calculated using the words.

In addition, the similarity between a source document and a target document can be calculated through a process similar to the processes illustrated in FIGS. 12A and 12B. That is, sentences may be extracted from the source and target documents, terms may be extracted from the sentences, and words may be extracted from the terms. Then, the similarity between the source document and the target document may be calculated using the similarities between the words.

FIG. 13 illustrates a preprocessing process according to an embodiment.

Of the preprocessing processes according to the inventive concept, the preprocessing process for replacing synonymous items with representative items and removing redundant representative items is illustrated in FIG. 13. Low-level items such as words or terms are rarely redundant. However, high-level items such as sentences or documents often have redundant expressions.

In FIG. 13, the sentence item [Target sales should definitely be entered. If the sales target is not entered, an error may occur.] is illustrated as an example. This item appears to be a sentence for providing an instruction message to users. To calculate the similarity between the above sentence and another sentence, low-level items, that is, terms and words such as [target sales], [definitely], [enter], [sales target], [enter], [error] and [occur] may be extracted.

Here, [target sales] and [sales target] are not the same term but are synonymous terms having the same meaning. If the S-T similarity is calculated by leaving these two terms as they are, the same similarity value can be reflected twice. Therefore, one of the two terms should be removed for accurate similarity calculation. This is the preprocessing process for replacing synonymous items with representative items and removing redundant representative items.

In the example of FIG. 8, the item [work goal registration] and the item [task goal input]are registered in the synonymous/similar dictionary as having a similarity value of 83.3%. Likewise, the item [target sales] and the item [sales target] can be stored in the synonymous/similar dictionary as having a similarity value of 100%.

In this case, when the synonymous/similar dictionary is actually constructed as a table in a database, the similarity may be managed using a source_item column indicating a source item, a target_item column indicating a target item, and a similarity_index column indicating similarity. In this case, if the similarity between two items is 100%, they are synonymous terms. Here, the source item may be defined as a representative item.

For example, if the table for managing similarity in the synonymous/similar dictionary has columns such as source_item, target_item and similarity_index and a row such as (target sales, sales target, 100%), [target sales] can be selected as a representative item of [sales target].

In the example of FIG. 13, the item [target sales] in the earlier part of the sentence and the item [target sales] selected as a representative item of [sales target] in the later part of the sentence are redundant. Thus, the item [sales target] in the later part may be removed. Likewise, since [enter] in the earlier part and [enter] in the later part are redundant, only one [enter] item may be left.

After redundant synonymous items are removed in this way, only the items [target sales], [definitely], [enter], [error] and [occur] can be used as source items 110 to calculate the similarity between the above sentence and another sentence.

However, the preprocessing process for removing redundant items is only an optional process. For example, the TF-IDF algorithm selects a keyword based on the frequency of a specific word in a document. In this case, redundant words may not be removed to calculate the similarity between the document and another document. Instead, the similarity may be calculated by giving a weight based on how often the specific word appears in the source document and the target document.

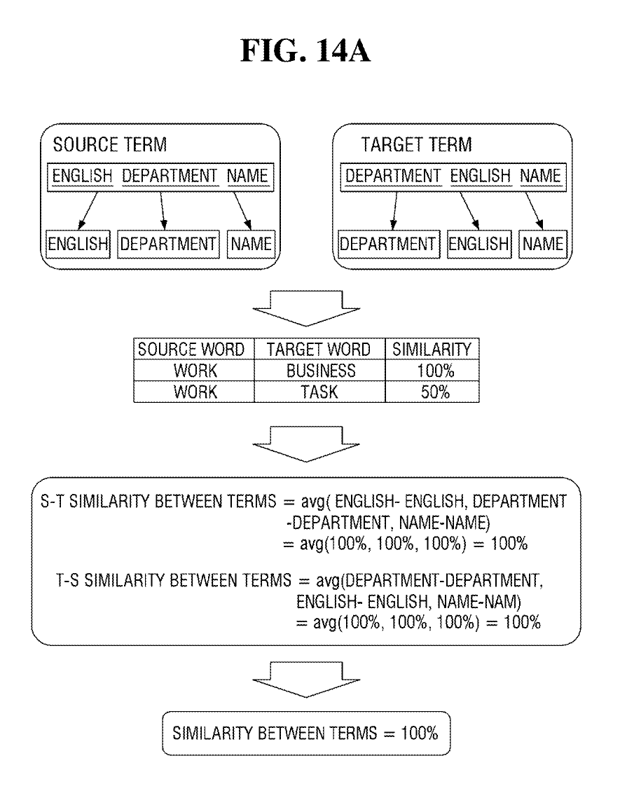

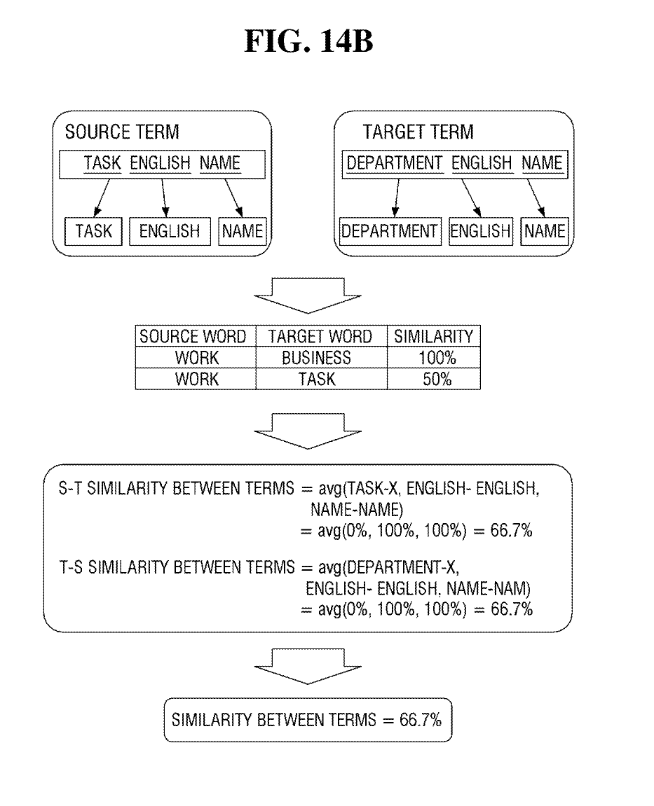

FIGS. 14A through 17B illustrate specific examples for explaining an item management method according to an embodiment.

In FIG. 14A, a process of calculating the similarity between a source term [English department name] and a target term [department English name] is illustrated. Since the two terms do not exist in a synonymous/similar dictionary, it is not possible to directly calculate the similarity between the two turns. Thus, each of the two terms should be divided into words, i.e., lower-level items to calculate the similarity between the two terms.

The source term [English department name] has source words of [English], [department] and [name], and the target term [department English name] has target words of [department], [English] and [name]. Although the source and target terms are different in the order of words, they include the same words. Therefore, the similarity between the two terms may be calculated to be 100%. That is, [English department name]and [department English name] are synonymous terms.

In actual similarity calculation, the S-T similarity is calculated to be 100% by avg(English-English, department-department, name-name)=avg(100%, 100%, 100%)=100%. Likewise, the T-S similarity is calculated to be 100% by avg(department-department, English-English. name-name)=avg(100%, 100%, 100%)=100%. Since the S-T similarity and the T-S similarity are equally 100%, min, max and avg are all 100%.

That is, the similarity between [English department name] and [department English name] has a value of 100%, and this value can be added to the synonymous/similar dictionary. In addition, when a user tries to register [English department name] as a new item, the user can be suggested to use [department English name] instead of registering [English department name].

In FIG. 14B, a process of calculating the similarity between a source term [task English name] and a target term [department English name] is illustrated. Since the two terms do not exist in the synonymous/similar dictionary, it is not possible to directly calculate the similarity between the two terms. Thus, each of the two terms should be divided into words, i.e., lower-level items to calculate the similarity between the two terms.

The source term [task English name] has source words of [task], [English] and [name], and the target term [department English name] has target words of [department], [English] and [name], Although [English] and [name] are common to the source term and the target term, there is a difference between [task] and [department]. Therefore, the similarity between the source term and the target term will be determined by the similarity between [task] and [department].

The similarity between [task] and [department] is not registered in the synonymous/similar dictionary. That is, the similarity between the two words is 0%. In actual similarity calculation, the S-T similarity is calculated to be 66.7% by avg(task-X, English-English, name-name)=avg(0%, 100%, 100%)=66.7%. Likewise, the T-S similarity is calculated to be 66.7% by avg(department-X, English-English, name-name)=avg(0%, 100%, 100%))=66.7%. Since the S-T similarity and the T-S similarity are equally 66.7%, min, max and avg are all 66.7%.

That is, the similarity between [task English name] and [department English name] has a value of 66.7%, and this value can be added to the synonymous/similar dictionary. In addition, when a user tries to register [task English name] as a new item, the user can be informed that [department English name] among terns registered in a systemhas a similarity of 66.7% to [task English name].

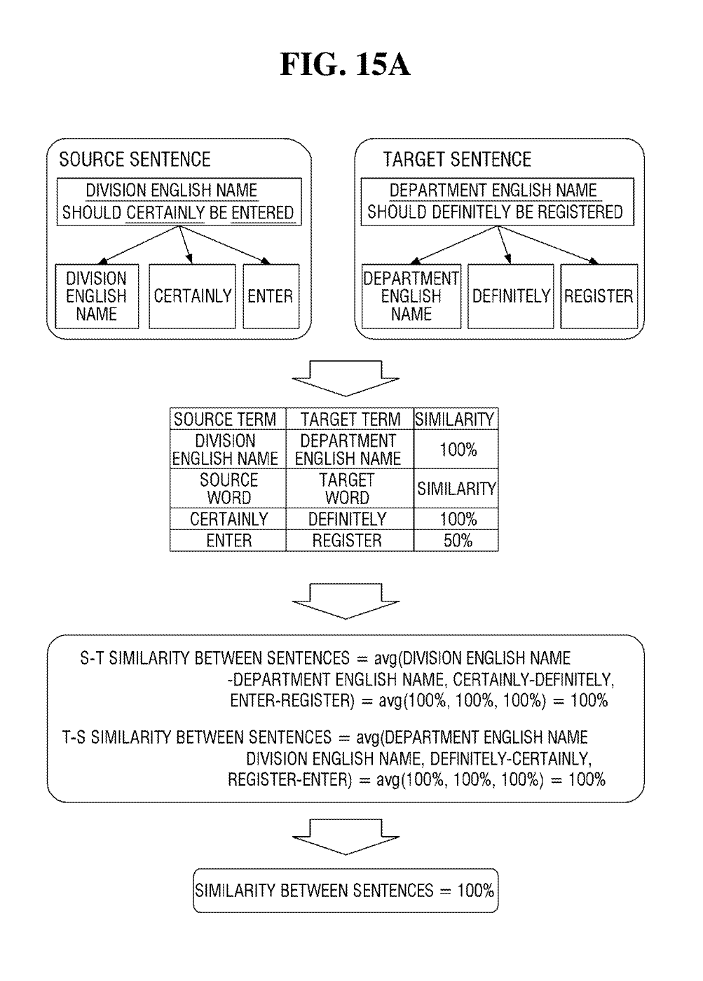

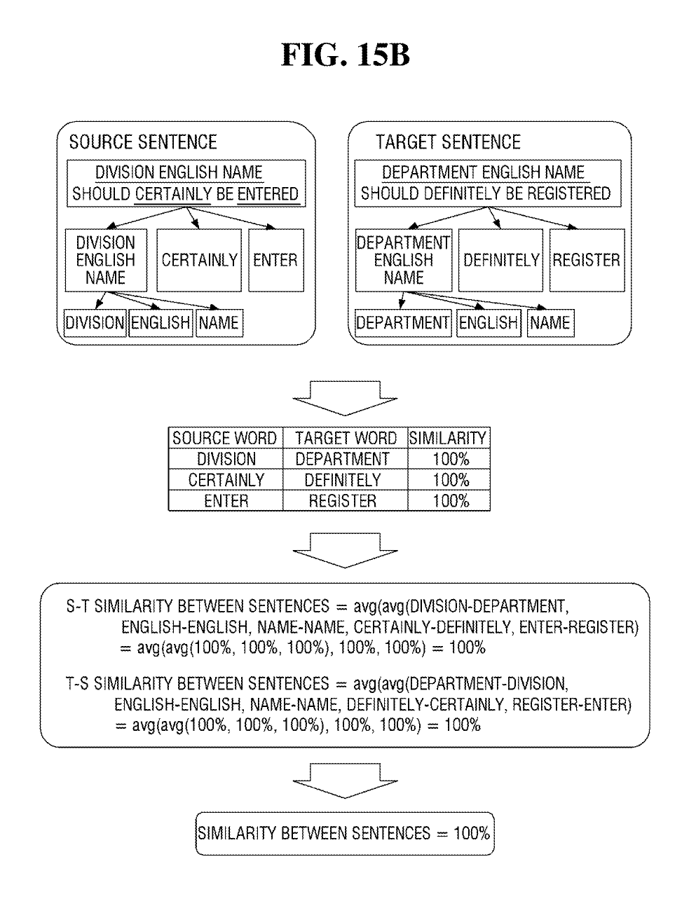

The process of calculating the similarity between terms has been described above with reference to FIGS. 14A and 14B. Hereinafter, a process of calculating the similarity between sentences will be described with reference to FIGS. 15A and 15B.

FIG. 15A, a process of calculating the similarity between a source sentence [Division English name should certainly be entered.] and a target sentence [Department English name should definitely be registered.] is illustrated. Since the two sentences do not exist in the synonymous/similar dictionary, it is not possible to directly calculate the similarity between the two sentences. Thus, each of the two sentences should be divided into terms and words, i.e., lower-level items to calculate the similarity between the two sentences.

The source sentence [Division English name should certainly be entered.] has a source term, of [division English name] and source words of [certainly] and [enter], and the target sentence [Department English name should definitely be registered.] has a target term of [department English name] and target words of [definitely] and [register].

Here, the similarity between the terms [division English name] and [department English name] is registered in the synonymous/similar dictionary. Therefore, there is no need to divide each of the two terms into words, i.e., lower-level. The similarity between the two sentences will be determined by the similarity between the terms [division English name] and [department English name], the similarity between the words [certainly] and [definitely], and the similarity between the words [enter] and [register].

In actual similarity calculation, the S-T similarity is calculated to be 100% by avg(division English name-department English name, certainly-definitely, enter-register)=avg(100%, 100%, 100%)=100%. Likewise, the T-S similarity is calculated to be 100% by avg(department English name-division English name, definitely-certainly, register-enter)=avg(100%, 100%, 100%)=100%. Since the S-T similarity and the T-S similarity are equally 100%, min, max and avg are all 100%.

That is, the similarity between [Division English name should certainly be entered.] and [Department English name should definitely be registered.] has a value of 100%, and this value can be added to the synonymous/similar dictionary. In addition, when a user tries to register [Division English name should certainly be entered.] as a new item for providing a new instruction message, the user can be suggested to use [Department English name should definitely be registered.] instead of registering [Division English name should certainly be entered.]. Accordingly, a uniform user environment can be provided.

Next, in FIG. 15B, the same source and target sentences as those in FIG. 15A are compared. However, a process of calculating the similarity between the source and target sentences in a case where the similarity between the terms [division English name] and [department English name] is not registered in the synonymous/similar dictionary is illustrated in FIG. 15B. FIG. 15B is the same as FIG. 15A. However, in FIG. 15B, the similarity between the terms [division English name] and [department English name] is not registered in the synonymous/similar dictionary. Instead, the similarity between the words [division] and [department]is registered in the synonymous/similar dictionary.

In this case, since the similarity between the terms [division English name] and [department English name] cannot be calculated directly, each of the two terms should be divided into words, i.e., lower-level items. The term [division English name] has sub-items of [division], [English], and [name], and the term [department English name] has sub-items of [department], [English], and [name]. Thus, the similarity between the two terms [division English name] and [department English name] will be determined by the similarity between the words [division] and [department].

In actual similarity calculation, the S-T similarity is calculated to be 100% by avg(avg(division-department, English-English, name-name), certainly-definitely, enter-register)=avg(avg(100%, 100%, 100%), 100%, 100%)=100%. Likewise, the T-S similarity is calculated to be 100% by avg(avg(department-division, English-English, name-name), definitely-certainly, register-enter)=avg(avg(100%, 100%, 100%), 100%, 100%)=100%. Since the S-T similarity and the T-S similarity are equally 100%, min, max and avg are all 100%.

As apparent from the example of FIG. 15B, even if the similarity between the terms [division English name] and [department English name] is not registered in the synonymous/similar dictionary, the similarity between the source and target sentences can be calculated by further dividing the two terms into words, i.e., lower-level items. As a result, the same value as in the case of FIG. 15A can be obtained.

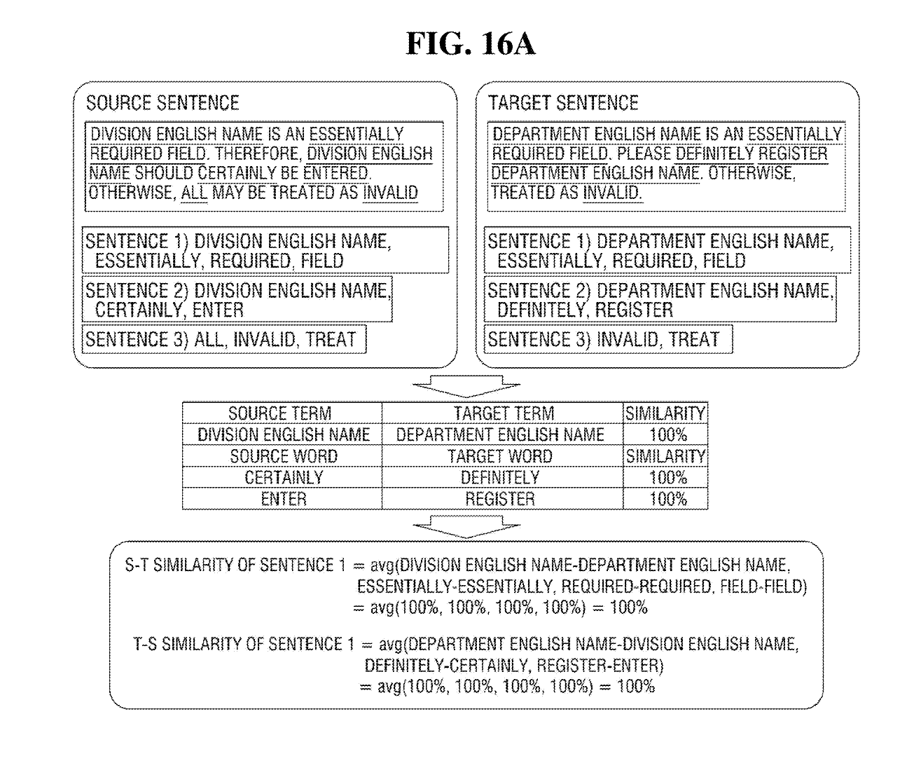

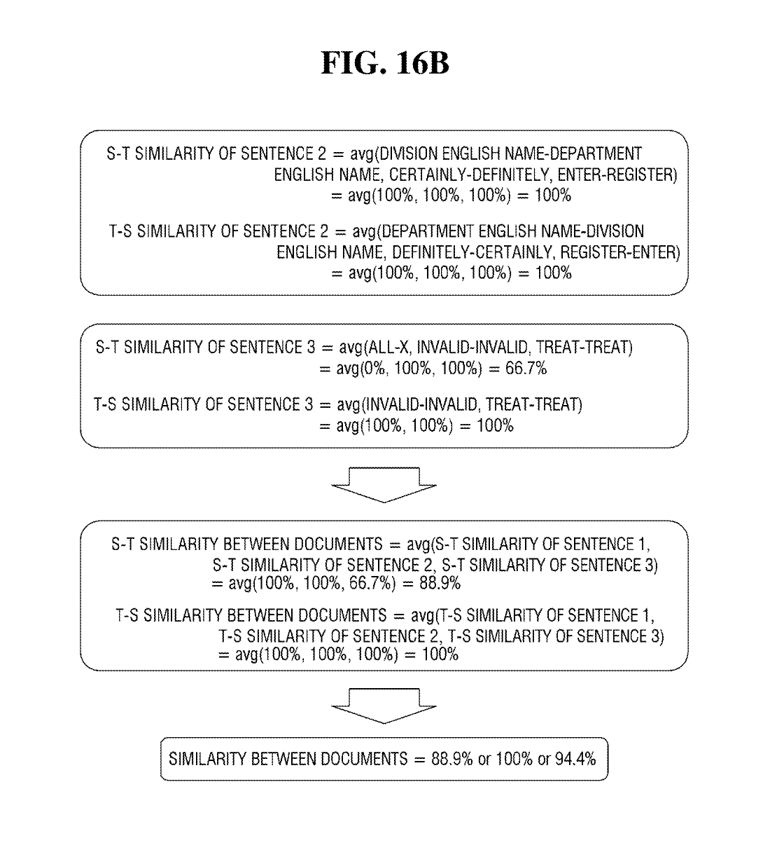

FIGS. 16A and 16B are examples for calculating the similarity between a source document and a target document. Since each document includes only three sentences, it is close to a paragraph rather than a document. However, FIGS. 16A and 16B are intended to show that the similarity between items including a plurality of sentences can also be calculated. Due to space constraints, one drawing is divided into FIG. 16A and FIG. 16B. FIG. 16B is a continuation of FIG. 16A.

Referring to FIG. 16A, a source document consists of three sentences [Division English name is an essentially required field. Therefore, division English name should certainly be entered. Otherwise, all may be treated as invalid.]. Similarly, a target document consists of three sentences [Department English name is an essentially required field. Please definitely register department English name. Otherwise, treated as invalid.].

To calculate the similarity between the source document and the target document, the source document may be divided into sentences based on periods. Then, terms and words of each sentence may be extracted as follows. First, the items [division English name], [essentially], [required] and [field] may be extracted from sentence 1 [Division English name is an essentially required field.] of the source document. In addition, the items [division English name], [certainly] and [enter] may be extracted from sentence 2 [Therefore, division English name should certainly be entered.] of the source document. Lastly, the items [all], [invalid] and [treat] may be extracted from sentence 3 [Otherwise, all may be treated as invalid.] of the source document.

Likewise, sentences may be extracted from the target document, and then each of the extracted sentences may be divided into s and words as follows. First, the items [department English name], [essentially], [required] and [field] may be extracted from sentence 1 [Department English name is an essentially required field.] of the target document. In addition, the items [department English name], [definitely] and [register] may be extracted from sentence 2 [Please definitely register department English name.] of the target document. Lastly, the items [invalid] and [treat] may be extracted from sentence 3 [Otherwise, treated as invalid.] of the target document.

After the preparations for calculating the similarity between the source document and the target document are complete, the similarity of each sentence is calculated as follows by referring to the similarities of terms and words registered in the synonymous/similar dictionary.

First, the S-T similarity of sentence 1 is calculated to be 100% by avg(division English name-department English name, essentially-essentially, required-required, field-field)=avg(100%, 100%, 100%, 100%)=100%. Likewise, the T-S similarity of sentence 1 is calculated to be 100% by avg(department English name-division English name, essentially-essentially, required-required, field-field)=avg(100%, 100%, 100%, 100%)=100%.

In FIG. 16B continued from FIG. 16A, the similarity of each of sentence 2 and sentence 3 is calculated. Referring to FIG. 16B, the S-T similarity of sentence 2 is calculated to be 100% by avg(division English name-department English name, certainly-definitely, enter-register)=avg(100%, 100%, 100%)=100%. Likewise, the T-S similarity of sentence 2 is calculated to be 100% by avg(department English name-division English name, definitely-certainly, register-enter)=avg(100%, 100%, 100%)=100%.

Next, the S-T similarity of sentence 3 is calculated to be 66.7% by avg(all-X, invalid-invalid, treat-treat)=avg(0%, 100%, 100%)=66.7%. Likewise, the T-S similarity of sentence 3 is calculated to be 100% by avg(invalid-invalid, treat-treat)=avg(100%, 100%)=100%.

Based on the S-T similarity and the T-S similarity of each sentence, the S-T similarity and the T-S similarity between the source document and the target document can be calculated as follows. The S-T similarity between the source and target documents is calculated to be 88.9% by avg(S-T similarity of sentence 1, S-T similarity of sentence 2, S-T similarity of sentence 3)=avg(100%, 100%, 66.7%)=88.9%. Likewise, the T-S similarity between the source and target documents is calculated to be 100% by avg(T-S similarity of sentence 1. T-S similarity of sentence 2, T-S similarity of sentence 3)=avg(100%, 100%, 100%)=100%.

Since the S-T similarity between the source and target documents is 88.9% and the T-S similarity is 100%, the minimum value is 88.9%, the maximum value is 100%, and the average value is 94.4%. The similarity between the source document and the target document can be determined to be any one of the above values as needed.

If the similarity between documents is calculated as described above, it is possible to recommend and use a similar word, a similar term, or a similar sentence when a document is created or when a dictionary is looked up. in addition, if there are documents or reports already created, it is possible to check for plagiarism through similarity analysis.

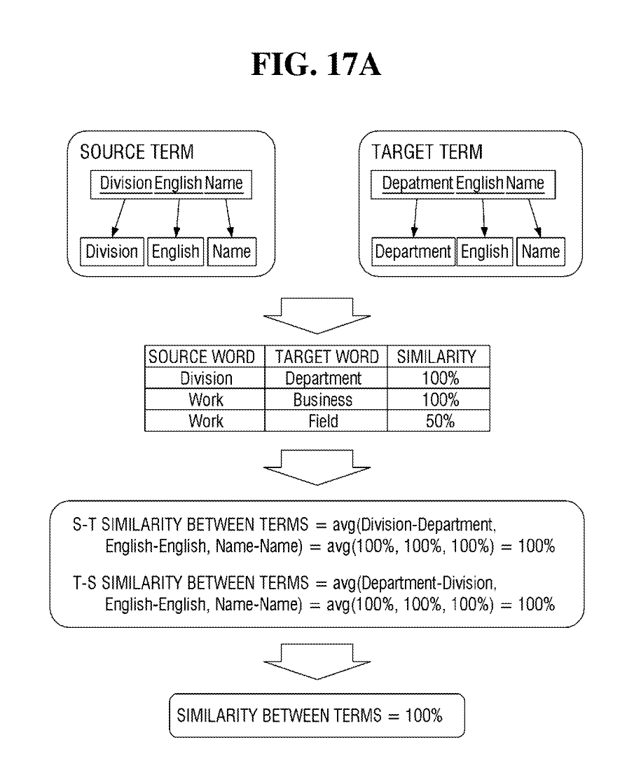

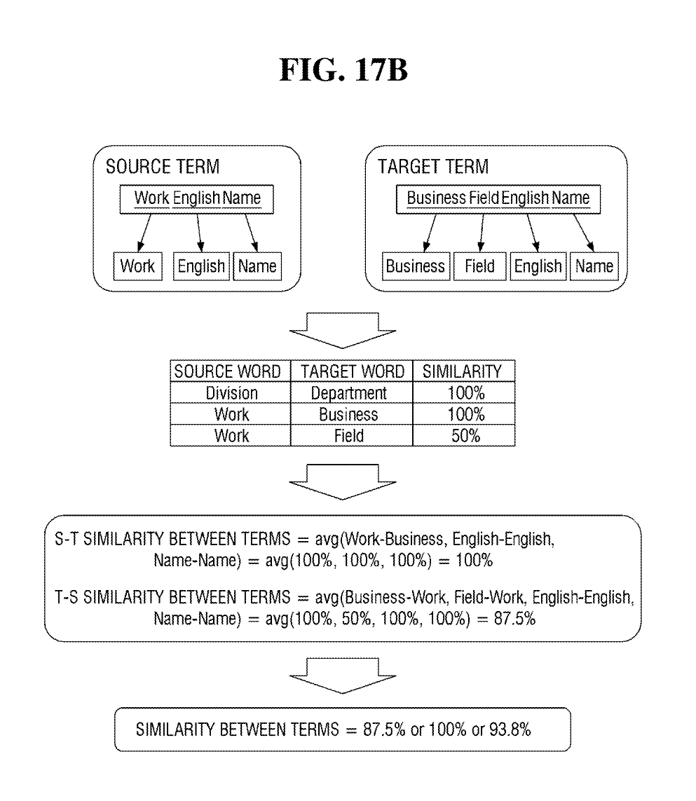

Until now, the cases where the similarity between terms, between sentences and between documents is calculated have been described with reference to FIGS. 14A through 16B. The method of managing synonymous items according to the inventive concept can also be applied to other languages besides Korean. An example in which the similarity between English terms is calculated will be described below with reference to FIGS. 17A and 17B.

Most languages other than Korean also have parts of speech or morphemes, and their meaning rarely changes according to placement order. Therefore, it is possible to calculate the similarity between words, between terms, between sentences, and between documents by applying rule 1 and rule 2 on which the inventive concept is based.

In FIG. 17A, a process of calculating the similarity between a source term [division English name] and a target term [department English name] is illustrated. Since the two terms do not exist in a synonymous/similar dictionary, it is not possible to directly calculate the similarity between the two terms. Thus, each of the two terms should be divided into words, i.e., lower-level items to calculate the similarity between the two terms.

The source term [division English name] has source words of [division], [English] and [name], and the target term [department English name] has target words of [department], [English] and [name]. Although [English] and [name] are common to the source term and the target term, there is a difference between [division] and [department]. Therefore, the similarity between the source term and the target term will be determined by the similarity between the two words.

In actual similarity calculation, the S-T similarity is calculated to be 100% by avg(division-department, English-English, name-name)=avg(100%, 100%, 100%)=100%. Likewise, the T-S similarity is calculated to be 100% by avg(department-division, English-English, name-name)=avg(100%, 100%, 100%)=100%. Since the S-T similarity and the T-S similarity are equally 100%, min, max and avg are all 100%.

That is, the similarity between [division English name] and [department English name] has a value of 100%, and this value can be added to the synonymous/similar dictionary. In addition, when a user tries to register [division English name] as a new item, the user can be suggested to use [department English name] instead of registering [division English name].

In FIG. 17B, a process of calculating the similarity between a source term [work English name]and a target terms [business field English name] is illustrated. Since the two terms do not exist in the synonymous/similar dictionary, it is not possible to directly calculate the similarity between the two terms. Thus, each of the two terms should be divided into words, i.e., lower-level items to calculate the similarity between the two terms.

The source term [work English name] has source words of [work], [English] and [name], and the target term [business field English name] has target words of [business], [field], [English] and [name]. Although [English] and [name] are common to the source term and the target term, there is a difference between [work] and [business] and [field]. Therefore, the similarity between the source term and the target term will be determined by the similarity between the words [work] and [business] and [field].

In actual similarity calculation, the S-T similarity is calculated to be 100% by avg(work-business, English-English, name-name)=avg(100%, 100%, 100%)=100%. Likewise, the T-S similarity is calculated to be 87.5% by avg(business-work, field-work, English-English, name-name)=avg(100%, 50%, 100%, 100%)=87.5%. Therefore, the similarity between the source term [work English name] and the target term [business field English name] has a minimum value of 87.5%, a maximum value of 100%, and an average value of 93.8%.

Until now, the processes of calculating the similarity between terms, between sentences and between documents based on the similarity between words (i.e., lower-level items than the terms, the sentences and the documents) registered in the synonymous/similar dictionary have been described with reference to the drawings. In particular, the above processes have been described based on the assumption that the similarity between words is 100% if the two words are synonymous words and is 50% if the two words are similar words. In addition, the above processes have been described based on the assumption that the synonymous/similar dictionary for words has already been constructed.

However, just like a new term is created, a new word can be created. When a new word is created, it is necessary to calculate the similarity between the new word and an existing word by comparing the new word and the existing word and to register the calculated similarity in the synonymous/similar dictionary. However, it would be very inconvenient to do this manually.

In this case, an external application programming interface (API) can be used. For example, using a Never search open API, the meaning of a new word may be found, and the similarity between the meaning of the new word and the meaning of an existing word may be calculated by applying the similarity calculation method of the inventive concept. Then, the calculated similarity may be automatically registered in the synonymous/similar dictionary.

Similarly, an external API can also be used for English. For example, an open API of the Oxford English Dictionary can be used to find the meanings of English words. More information about the open API of the Oxford English Dictionary can be found at http://public.oed.com/subscriber-services/sru-service/. In this way, the meanings of newly created words can be collected through various external APIs.

For example, let's assume that word similarity management is automated using the Naver Dictionary. Here, the word [success] is already registered in the system. If [success] is looked up in the Naver dictionary, the following definition can be obtained: “success: accomplishing what has been aimed.” In this case, if [achievement] is newly created, there is no need for a person to artificially calculate the similarity between [success] and [achievement]. Instead, using the open API, it is possible to look up “achievement” in the Naver dictionary, store the meaning of “achievement” in the system, and calculate the similarity between the meaning of “achievement” and the meaning of [success].

If “achievement” is looked up in the Naver dictionary, the following definition can be obtained: “achievement: accomplishing what has been aimed.” Then, the similarity between the meaning of “success” and the meaning of “achievement” can be calculated, and the calculated similarity can be used as the similarity of [success] and [achievement]. That is, it can be identified that [success] and [achievement] are synonymous words having a similarity of 100% through avg(aim-aim, what-what, accomplishing-accomplishing)=avg(100%, 100%, 100%)=100%.

In this way, if the meaning of a new word is looked up in an external dictionary using an open API and if the similarity between a sentence retrieved as the meaning of the new word and a sentence retrieved as the meaning of an existing word is calculated, the similarity between the new word and the existing word can be automatically managed in the synonymous/similar dictionary. In this case, the similarity between similar words is not fixed at 50% as assumed above. Instead, the similarity will have various values due to words included in the meaning of each word.

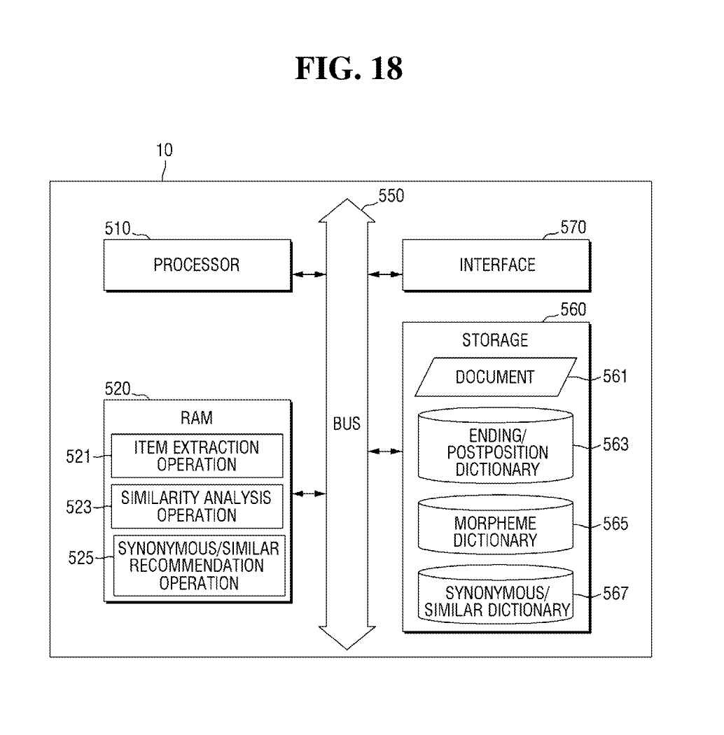

FIG. 18 illustrates the hardware configuration of an apparatus 10 for managing synonymous items based on similarity analysis according to an embodiment.

Referring to FIG. 18, the apparatus 10 for managing synonymous items based on similarity analysis according to the embodiment may include one or more processors 510, a memory 520, a storage 560, and an interface 570. The processors 510, the memory 520, the storage 560 and the interface 570 transmit and receive data through a system bus 550.

The processors 510 execute a computer program loaded into the memory 520, and the memory 520 loads the computer program from the storage 560. The computer program may include an item extraction operation 521, a similarity analysis operation 523, and a synonymous/similar recommendation operation 525.

The item extraction operation 521 may read a document 561 from the storage 560 and load the read document 561 into the memory 520 through the system bus 550. Then, the item extraction operation 521 may extract sentences from the document 561 based on periods, extract terms based on an ending/postposition dictionary of the storage 560 and spacing, and extract words based on a morpheme dictionary 565 of the storage 560.

When the item extraction operation 521 extracts sentences, terms, and words from each of a first document and a second document, it is not possible to directly calculate the similarity between the first document and the second document. However, it is possible to indirectly calculate the similarity between the first document and the second document using the similarity of each sentence, term, and word constituting the first document and the second document.

The similarity analysis operation 523 may calculate the similarity between the first document and the second document by referring to a synonymous/similar dictionary 567 of the storage 560. If the similarity between the first document and the second document is registered in the synonymous/similar dictionary 567, it can be used. However, if the similarity between the first document and the second document is not registered in the synonymous/similar dictionary 567, it may be calculated using the similarity between a first sentence constituting the first document and a second sentence constituting the second document.

If the similarity between the first sentence and the second sentence is not registered in the synonymous/similar dictionary 567, it may also be calculated using the similarity between a first term constituting the first sentence and a second term constituting the second sentence. If the similarity between the first term and the second term is not registered in the synonymous/similar dictionary 567, it may be calculated using the similarity between a first word constituting the first term and a second word constituting the second term.

Using the analysis result of the similarity analysis operation 523, the synonymous/similar recommendation operation 525 may recommend a synonymous/similar document, sentence, term, or word. The recommended synonymous/similar document, sentence, term, or word can be used by a user to create a document or look up a dictionary. Alternatively, the recommended synonymous/similar document, sentence, term, or word can be used to check for plagiarism by analyzing the similarity between documents and reports.

Alternatively, a document highly relevant to a specific paper can be retrieved and provided, or a patent document highly relevant to a specific patent document can be retrieved and provided. The recommended synonymous/similar word, term, sentence, or document may be provided to a user through the interface 570 via a network.

Each component described above with reference to FIG. 18 may be implemented as a software component or a hardware component such as a field programmable gate array (FPGA) or application-specific integrated circuit (ASIC). However, the components are not limited to the software or hardware components and may be configured to reside on the addressable storage medium or configured to execute one or more processors. The functionality provided for in the components may be combined into fewer components or further separated into additional components.

Embodiments provide at least one of the following advantages.

There have been many cases where synonyms, which have not been recognized by humans or have not been registered in advance in a synonymous/similar dictionary, are redundantly registered in a system. Actually, when a large-scale next-generation project is carried out in the field of finance, manufacturing, etc. there are a large number of synonymous information items. Therefore, a large amount of time and money are required to find information items necessary for analysis when a data warehouse system is constructed or when statistical information for each period is generated. This results in a vicious cycle of data quality degradation.

On the other hand, when information items are managed using a method according to an embodiment, it is possible to automatically calculate the similarity between terms created by combining words which are minimum units of meaning, the similarity between sentences, and the similarity between documents based on a synonymous/similar word dictionary. Accordingly, it is possible to select and provide a synonymous term, a synonymous sentence, or a synonymous document to a user. That is, even new term, new sentence, or a new document is not registered in a synonymous/similar dictionary, the similarity of each information can be identified.

However, the effects of the inventive concept are not restricted to the one set forth herein. The above and other effects of the inventive concept will become more apparent to one of daily skill in the art to which the inventive concept pertains by referencing the claims.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of managing synonymous items based on similarity analysis, the method performed by a similarity analysis apparatus and comprising:
extracting, from a first item, (1-1)-th through (1-m)-th items, which are first sub-items of the first item in a database;
extracting, from a second item, (2-1)-th through (2-n)-th items, which are second sub-items of the second item in the database;
calculating, via an at least one processor of the similarity analysis apparatus, a source-target (S-T) similarity score based on a first similarity between the (1-1)-th through (1-m)-th items and the second sub-items of the second item;
calculating, via the at least one processor, a target-source (T-S) similarity score based on a second similarity between the (2-1)-th through (2-n)-th items and the first sub-items of the first item; and
calculating, via the at least one processor, a similarity score between the first item and the second item based on the S-T similarity score and the T-S similarity score,
wherein the S-T similarity score is calculated based on a first number of sub-items constituting a source item that are included in a target item, and
wherein the T-S similarity score is calculated based on a second number of sub-items constituting the target item that are included in the source item.

2. The method of claim 1, further comprising storing the similarity score between the first item and the second item in a synonym database.

3. The method of claim 1, further comprising, in response to a database query to retrieve the first item, providing the second item instead of the first item when the similarity score between the first item and the second item is greater than or equal to a threshold value.

4. The method of claim 1, further comprising determining that the first item is plagiarized from the second item when the similarity score between the first item and the second item is greater than or equal to a threshold value.

5. The method of claim 1, wherein the extracting the (1-1)-th through (1-m)-th items from the first item comprises removing at least one of an ending and a postposition of the first item.

6. The method of claim 1, wherein the extracting the (1-1)-th through (1-m)-th items comprises selecting two arbitrary items from the (1-1)-th through (1-m)-th items and excluding any one of the two arbitrary items when a similarity score between the two arbitrary items is greater than or equal to a threshold value.

7. The method of claim 1, wherein the first item and the second item are documents, the (1-1)-th through (1-m)-th items and the (2-1)-th through (2-n)-th items are sentences, and the extracting the (1-1)-th through (1-m)-th items and the extracting the (2-1)-th through (2-n)-th items comprise extracting the sentences from one of the documents based on locations of period symbols.

8. The method of claim 1, wherein the first item and the second item are sentences, the (1-1)-th through (1-m)-th items and the (2-1)-th through (2-n)-th items are terms, and the extracting the (1-1)-th through (1-m)-th items and the extracting the (2-1)-th through (2-n)-th items comprise extracting the terms from one of the sentences based on at least one of spacing, endings, and postpositions.

9. The method of claim 1, wherein the first item and the second item are terms, the (1-1)-th through (1-m)-th items and the (2-1)-th through (2-n)-th items are words, and the extracting the (1-1)-th through (1-m)-th items and the extracting the (2-1)-th through (2-n)-th items comprise extracting the words, which are minimum units of meaning, from one of the terms based on morphemes.

10. The method of claim 1, wherein the calculating the S-T similarity score comprises:
comparing each of the (1-1)-th through (1-m)-th items with a first sub-item of the second item by referencing a synonym database; and
calculating the S-T similarity score by averaging values of respective similarity scores of the (1-1)-th through (1-m)-th items.

11. The method of claim 10, wherein the comparing the each of the (1-1)-th through (1-m)-th items with the first sub-item of the second item comprises, when similarity information regarding a specific item among the (1-1)-th through (1-m)-th items in relation to the first sub-item of the second item is absent in the synonym database:
extracting a third item which is a second sub-item of the specific item; and
determining a third similarity between the third item and a third sub-item of the second sub-item of the second item by referencing the synonym database.

12. The method of claim 1, wherein the calculating the T-S similarity score comprises:
comparing each of the (2-1)-th through (2-n)-th items with a first sub-item of the first item by referencing a synonym database; and
calculating the T-S similarity score by averaging values of respective similarity scores of the (2-1)-th through (2-n)-th items.

13. The method of claim 12, wherein the comparing the each of the (2-1)-th through (2-n)-th items with the first sub-item of the first item comprises, when similarity information regarding a specific item among the (2-1)-th through (2-n)-th items in relation to the first sub-item of the first item is absent in the synonym database:
extracting a third item which is a second sub-item of the specific item; and
determining a third similarity between the third item and a third sub-item of the second sub-item of the first item by referencing the synonym database.

14. The method of claim 1, wherein the calculating the similarity score between the first item and the second item comprises calculating any one of a minimum value among the S-T similarity score and the T-S similarity score, a maximum value among the S-T similarity score and the T-S similarity score, and an average value of the S-T similarity score and the T-S similarity score.
